(19) United States
(12) Patent Application Publication
(10) Pub. No.: US 2003/0115038 A1
(43) Pub. Date: Jun. 19, 2003

(54) Method and device for emulating electronic apparatus

(76) Inventors: Roy Want, Los Altos, CA (US); James Kardach, Saratoga, CA (US); Graham D. Kirby, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/025,268

(22) Filed: Dec. 18, 2001

(51) Int. Cl. G06F 9/455

(52) U.S. Cl. 703/24

(57) ABSTRACT

A method and system for emulating an electronic apparatus is provided. The system includes a portable electronic device to emulate functionality provided by the electronic apparatus, and a separate access device. The portable electronic device includes a wireless communication module and the access device includes a display and a wireless communication interface to communicate with the wireless communication module when the portable electronic device is within wireless communication range of the access device. The display provides a display layout that simulates the physical appearance of the electronic apparatus.

### FIELD OF THE INVENTION

The present invention relates generally to the field of portable electronic devices and, more specifically, to a portable electronic device for emulating electronic apparatus.

### BACKGROUND OF THE INVENTION

In the current era of technology, people generally have a large number of different electronic apparatus each providing different functionality. Typical examples of such apparatus are personal digital assistants (PDAs), laptop computers, portable audio players (e.g., MP3 players), digital watches, an electronic book (a softbook, a Franklin databook or the like), a dictionary (e.g. such as that made by Franklin, Casio), a calculator, a cellular telephone, a calorie counter, a game playing device (e.g. a Gameboy device), and a smart card or the like. Typically, these different types of apparatus are in the form of individual self-contained units that are used independently to perform different tasks. The result is that a user must carry a separate apparatus if he or she wishes to enjoy the functionality associated with the apparatus.

### BRIEF DESCRIPTION OF THE DRAWINGS

The invention is now described, by way of example, with reference to the accompanying diagrammatic drawings.

In the drawings:

FIG. 1 shows a schematic block diagram of an emulation system in accordance with one embodiment of the invention;

FIG. 2 shows a schematic block diagram of a portable electronic device in accordance with a further embodiment of the invention;

FIG. 3 shows a schematic flow chart of a method, in accordance with a further embodiment of the invention, of interfacing the portable electronic device with a user interface;

FIG. 4 shows a schematic diagram of the communication of information between the portable electronic device of FIG. 2 and a user; and

FIG. 5 shows a schematic representation of a display layout generated by the system of FIG. 1.

### DETAILED DESCRIPTION

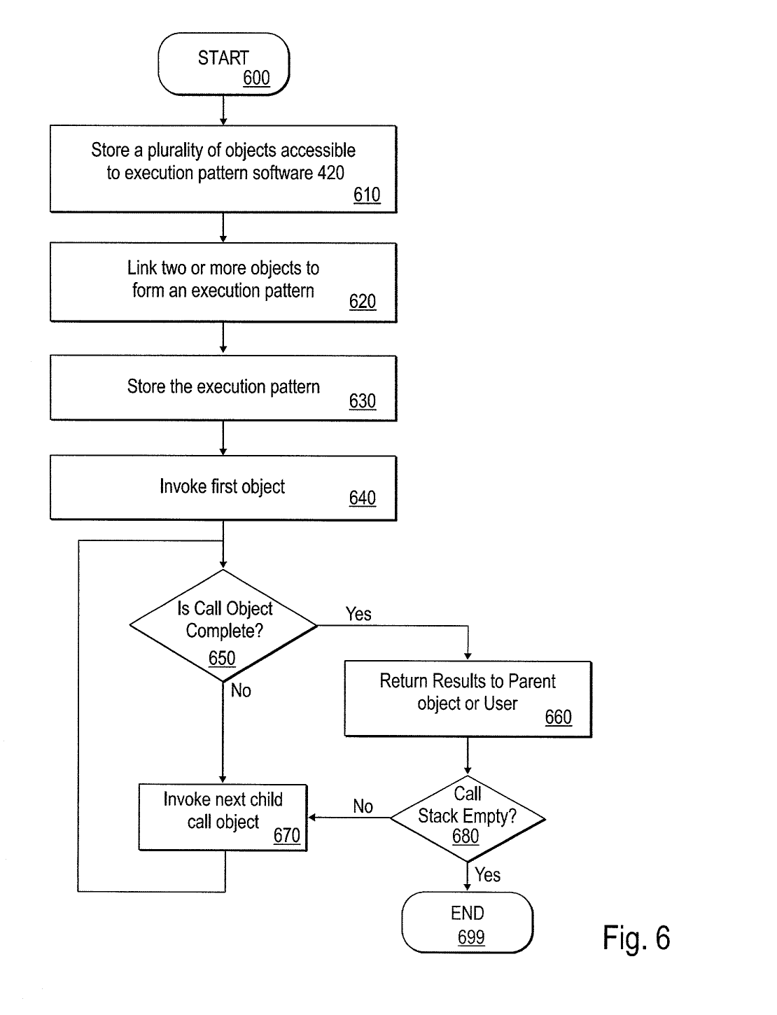

Referring to the drawings, reference numeral 10 generally indicates an emulation system, in accordance with the invention, for emulating electronic apparatus. The system 10 includes a separate access device 12 that communicates in a wireless fashion with a portable electronic device 14. As described in more detail below, the portable electronic device 14 emulates the functionality provided by the electronic apparatus and communicates display data to the access device 12 which, in turn, provides a display layout 16 (see FIG. 5) which substantially resembles and simulates the physical appearance of the electronic apparatus. The display layout 16 provided in FIG. 5 resembles a personal digital assistant (PDA) but, it is to be appreciated, that electronic apparatus in any form, e.g., an MP3 player, personal information management systems (PIMS), TV remote controls, or any other electronic apparatus may be emulated by the system 12.

In the embodiment depicted in the drawings, the access device 12 is in the form of a personal computer (PC) 18. The PC 18 has an operating system 20, an installable file system 22, a hard disc drive 24, a compact disk or CD drive 26, a floppy disk drive 28, and a radio frequency (RF) wireless communication interface 30 which includes a bluetooth stack 32 and bluetooth hardware 34. The PC 18 further includes a display 36 (see FIG. 5) on which the display layout 16 is displayed. Although the access device in the example depicted in the drawings in the form of a PC 18, it is to be appreciated that the access device may take on various other forms e.g., the access device may be personal digital assistant (PDA) or any other electronic hardware that typically provides a visual and/or audio output to a user. Thus, for the purposes of this specification, the term “access device” should be interpreted broadly to include any man/machine interface that a user may interact with irrespective of its processing capabilities. Further, the processing capabilities and IO hardware may vary from access device to access device.

The portable electronic device 14 includes an operating system 37, a mass storage module 38, e.g., a hard disc drive, and a wireless communication module 40 which includes a bluetooth stack 42 and bluetooth hardware 44. The wireless communication module 40 and the wireless communication interface 30 communicate with each other using standard bluetooth IEEE 802.15 communication protocols when within a limited wireless communication range. Typically, universal plug and play (UPnP) technology is used so that, when the portable electronic device 14 is within the wireless communication range of an access device 12, communications can be established so that the portable electronic device 14 may emulate the electronic apparatus on any one of the plurality of different access devices 12 at different physical locations. Thus, a person or bearer of the portable electronic device 14 may use any access device 12 which is at a location proximate to the user.

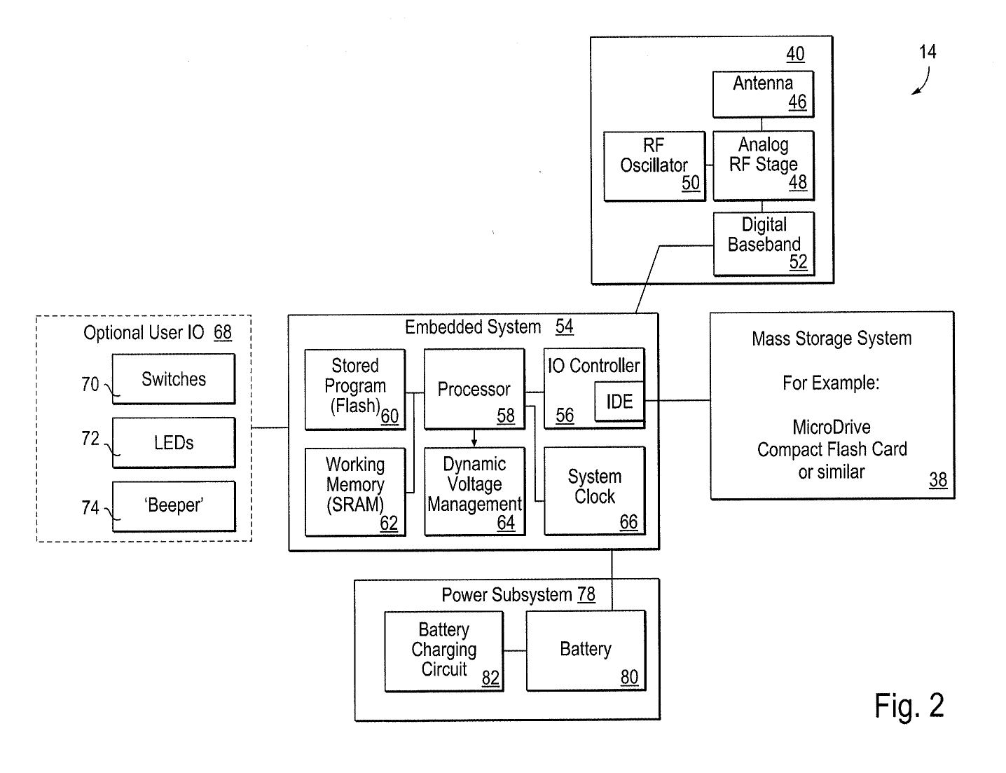

Referring in particular to FIG. 2 of the drawings, a more detailed description of the portable electronic device 14 is provided. The wireless communication module 40 includes an antenna 46, an analog RF stage 48, an RF oscillator 50, and digital baseband circuitry 52. As mentioned above, the wireless communication module 40 typically communicates using conventional bluetooth communication protocols and may be a conventional Intel™ Ambler module. However, it is to be appreciated, that any other wireless transceiver using a standardized wireless communication protocol, e.g., IEEE 802.11b or IEEE 802.11a may be used.

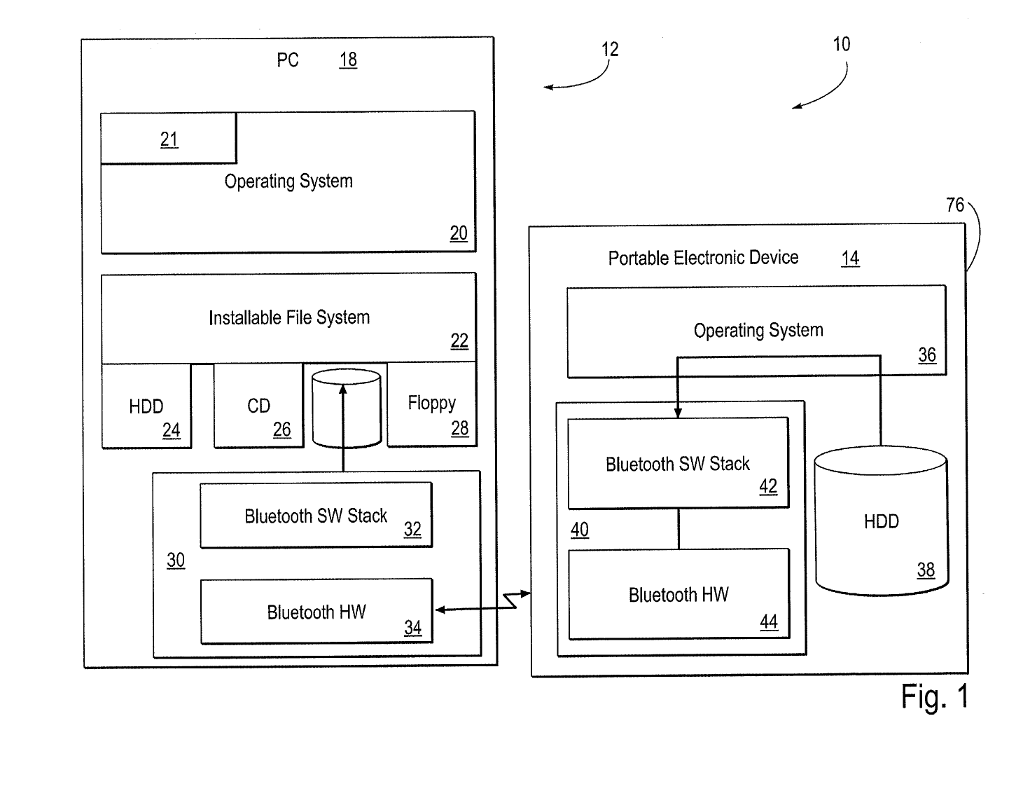

The portable electronic device 14 typically includes an embedded system 54 which includes an 10 controller 56, a processor 58, a stored program 60 (which may include the operating system 37), working memory 62, a dynamic voltage management circuit 64, and a system clock 66. The mass storage module 38, in alternative embodiments of the invention, may include a microdrive, a compact flash card, or any other storage device for storing bulk data. Further, the portable electronic device 14 includes an optional user interface 68 that has switches 70, light emitting diodes or LEDs 72, and an audio interface in the form of beeper 74. In certain embodiments, the switches 70 are in the form of thumbwheel switches to allow a user, in a menu driven fashion, to provide input to the portable electronic device 14 based on the state of the display 36 of the access device 12. In order to facilitate portability of the portable electronic device 14, a compact housing 76 (See FIG. 1) is provided. Attached to the compact housing is a power sub-system 78 that includes a rechargeable battery 80 and battery charging circuit 82. The portable electronic device 14 thus forms a self-contained unit which, when in proximity to the access device 12, emulates electronic apparatus, as described in more detail below.

The portable electronic device 14 may be configured to emulate one or more different types of electronic apparatus and a user may thus select any one or more of the apparatus thereby to enjoy its functionality when in proximity to the access device 12. For example, the user may select an electronic apparatus to emulate by using the switches 70 in a menu driven fashion as described above. For example, the electronic apparatus may be an MP3 player and, accordingly, the portable electronic device 14 may thus emulate an MP3 player. Accordingly, MP3 files which define emulation data may be stored in the storage module 38 as well as display data in the form of skins which, when displayed on the display 36, provide a display layout 16 which substantially simulates a physical appearance of an MP3 player. As described in more detail below, the portable device 14 may then communicate the display data and the emulation data to the access device 12, which may then provide an audio output of the MP3 files under control of the portable electronic device 14.

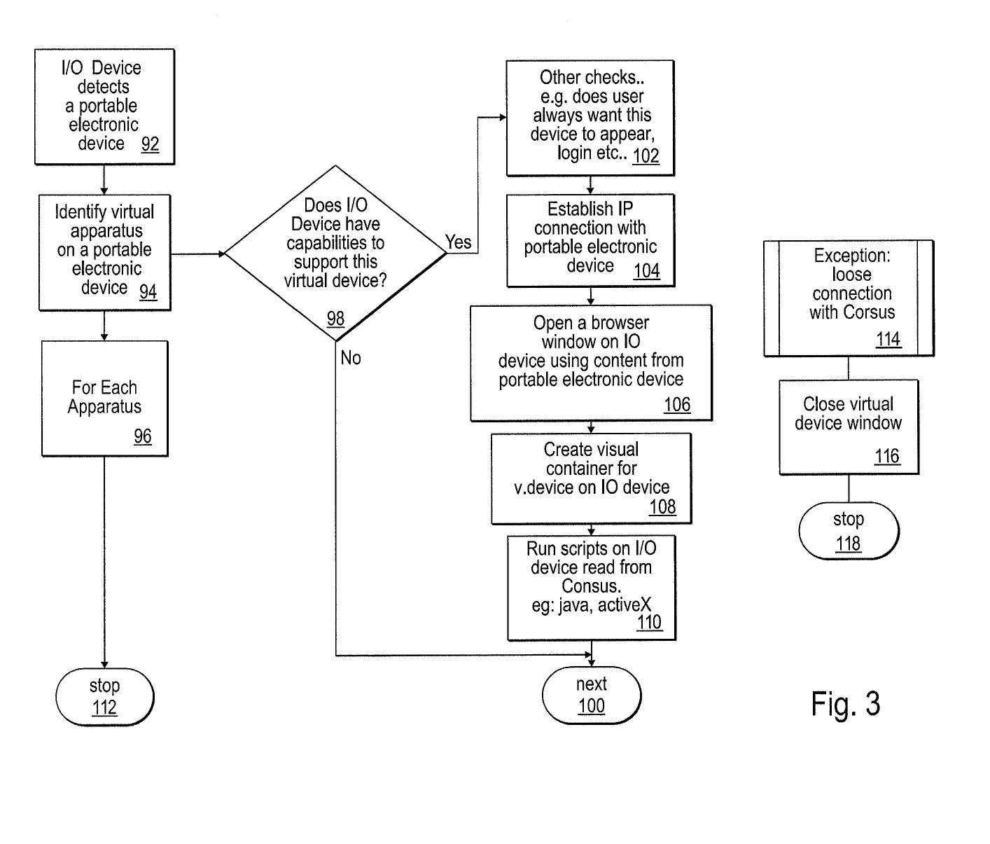

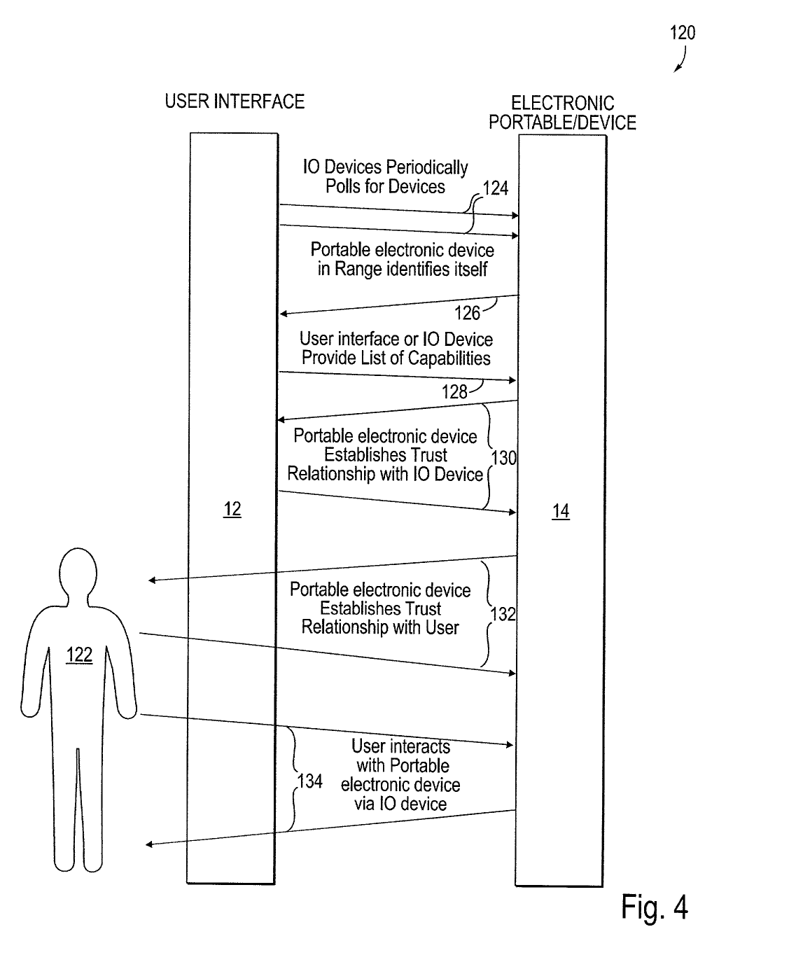

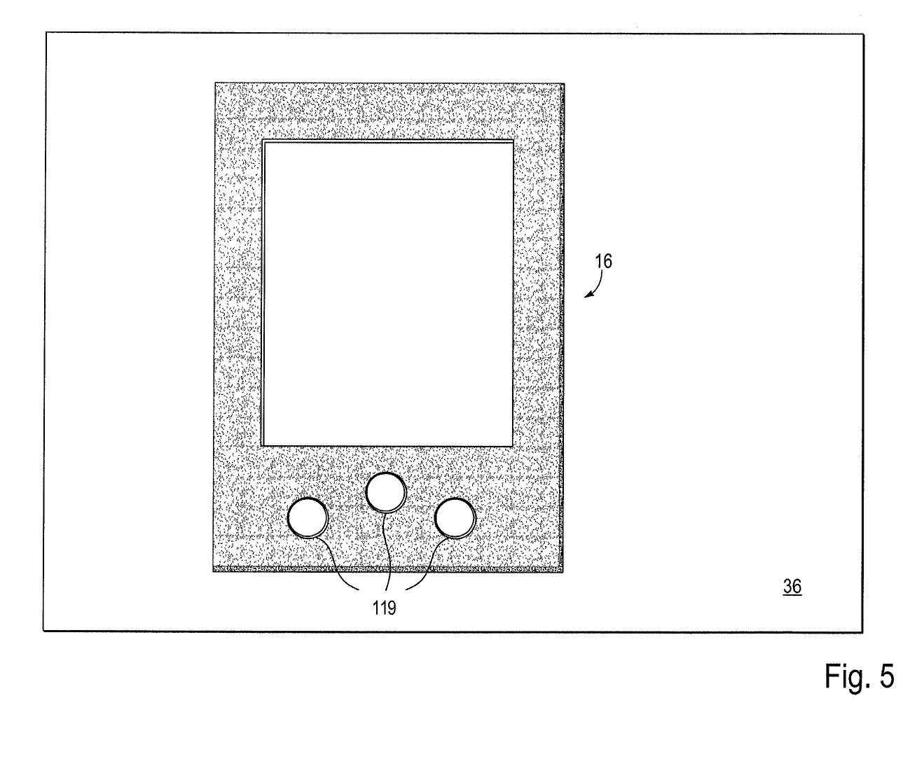

Referring in particular to FIG. 3 of the drawings, reference numeral 90 generally indicates a method of interfacing the access device 12 with the portable electronic device 14. The method 90 is typically implemented by software code and included in a computer program product including a medium readable by a processor e.g., a processor 21 of the PC 18. The method 90 is typically run on the PC 18, or any other access device 12, and detects when a portable electronic device 14 is within a wireless communication range (see step 92). When the portable electronic device 14 is detected, the method 90 communicates with the portable electronic device 14 to determine which one or more different types of electronic apparatus the portable electronic device 14 wishes to emulate. The portable electronic device 14 may thus define a virtual apparatus corresponding to the electronic apparatus and the method 90 may thus detect which particular virtual apparatus is emulated by the portable electronic device (as shown at step 94). For each particular apparatus which the method 90 detects that the portable electronic device 14 wishes to emulate, the method 90 checks whether or not the access device 12 has the processing capabilities to provide the appropriate user interface for the portable electronic device 14 (see step 96). In particular, as shown at step 98, the method 90 checks to see whether the access device 12 has the appropriate I/O capabilities to support the particular electronic apparatus. If the access device 12 is unable to support the particular electronic apparatus, the method proceeds to step 100 where the requirements of the next particular electronic apparatus are checked.

If, however, the access device has the capabilities to provide the necessary output to emulate the functionality of the particular electronic apparatus, the method proceeds to step 102 where other checks, e.g., user defined requirements, are carried out. For example, the method 90 may ascertain whether or not the user wishes the particular electronic apparatus to be emulated in an automated fashion whenever the user, bearing the portable electronic device 14, is within the wireless communication range of any access device 12. Further, the method 90 may require a login procedure where the user logs the portable electronic device onto the access device 12. Thereafter, an Internet Protocol (IP) connection is established between the portable electronic device 14 and the access device 12, as shown at step 104, and a browser window on the display 36 is opened. The IP connection typically involves executing the HTTP protocol over a TCP/IP connection and then transferring HTML files across this reliable end-to-end link. The display layout 16 provided on the display 36 uses the display data sourced from the portable electronic device 14 and, as described above, the display layout 16 simulates the physical appearance of particular the portable electronic apparatus being emulated by the portable electronic device 14 (see step 106). The method 90 creates a visual container (see step 108) for the virtual apparatus or particular electronic apparatus on the access device 12 and runs scripts on the access device 12 which are read from the portable electronic device 14 (see step 110). The scripts are typically java scripts, activeX scripts, or the like. Steps 102 to 110 are repeated iteratively for each particular electronic apparatus or virtual apparatus that the method 90 detects on the portable electronic device 14.

Once all the electronic apparatus that the portable electronic device 14 wishes to emulate have been determined, the method 90 terminates, as shown at step 112, whereafter the portable electronic device 14 controls further communication of data to the access device 12. If, however, the connection to the portable electronic device 14 and the access device 12 is broken, as shown at step 114, the virtual window or display layout 16 is closed (see step 116) and the method 90 terminates see block 118. Typically, each portable electronic device 14 emulates a number of different types of electronic apparatus and, accordingly, the portable electronic device 14 may for example thus connect multiple times to the access device 12.

During each connection, data specific to the particular electronic apparatus may be exchanged. In certain embodiments, and dependent upon the nature of the access device 12, multiple electronic apparatus may be emulated simultaneously. Depending upon the specific type of electronic apparatus that the portable electronic device 14 emulates, a trust relationship may be established between the portable electronic device 14 and the access device 12. For example the portable electronic device 14 may include a connect filter which defines a control mechanism set up by, and under the control of, a user of the personal electronic device 14. In certain embodiments, once a trust relationship has been established between the access device 12 and the personal electronic device 14, the identity of the access device 12 will have been established in a reliable way. The identity may, for example, be described in terms of a textual string. For each apparatus that may be emulated by on the access device 12, there may be some restriction as to what access device 12 can access a particular portable electronic device 14. For instance, emulation of a calculator is likely to have no restriction based on the access device 12, but a medical-data smart-card emulation may have access restricted to access-devices 12 owned by doctors and medical staff of a particular hospital or HMO. The connect filter may thus include a table that specifies the access rights of particular access devices 12, or a class of access device 12, relating to the various apparatus emulated by the personal electronic device 12. The portable electronic device 12 can then perform a simple look-up function to decide if a connection between an access device 12 and a particular emulated apparatus should be made.

The portable electronic device 14 and the access device 12 are arranged so that they only establish substantive communications between each other when they are within a predetermined physical range of each other. Typically, the access device 12 monitors a restricted physical area and, when a user bearing a portable electronic device 14 is within this restricted area, the access device 12 considers the person to be within a sufficiently close physical range on a human scale to commence communications with the portable electronic device 14. The sufficiently close human scale may thus be contrasted with the non-human wireless communication range. Thus, the predetermined physical range is substantially less than the wireless communication range, the physical range defining a restricted zone within which the access device 12 assumes that a particular user, which is in close proximity to the access device 12, requires use of the access device 12.

The display data is typically in the form of a plurality of skins that also define function buttons 119. The function buttons 119 resemble and simulate the physical appearance of the actual function buttons on the electronic apparatus. When a pointing device selects or activates a particular function button 119, the portable electronic device 14 emulates the functionality that would be executed by the actual electronic apparatus and communicates the associated emulation data to the access device 12. The access device 12 may receive display and emulation data in the form of HTML pages.

Reference numeral 120 generally indicates the interaction between the portable electronic device 14, the access device 12, and a user 122. Typically, the access device 12, which may be defined by the PC 18, periodically polls using its wireless communication interface 30 for the presence of a portable electronic device 14 within it wireless communication range as shown by lines 124. When a particular portable electronic device 14 is within the wireless communication range, the portable electronic device 14 typically identifies itself (as shown by line 126) whereafter the access device 12 communicates its processing capabilities (which include its display capabilities as well as 10 capabilities such as audio and/or multimedia capabilities) to the portable electronic device 14 as shown by line 128. Thereafter, a trust relationship (which may use conventional security techniques) is established between the portable electronic device 14 and the access device 12 as shown by lines 130. Once the particular trust relationship between the access device 12 and portable electronic device 14 is established, a trust relationship is then established between the user 122 and the portable electronic device 14 as shown by lines 132. For example, this may require the user 122 to enter a user name and password into the access device 12 which is then verified by the portable electronic device 14 to allow the user 122, bearing the portable electronic device 14, to use the portable electronic device 14. When the trust relationship between the user 122 and the portable electronic device 14 has been established, the user may then interact with the portable electronic device via the access device 12 (as shown by lines 134) and enjoy the functionality emulated by the portable electronic devicel4.

As a standardized communication protocol is used by the portable electronic device 14, any one of a variety of different access devices 12 may be used by the user 122 to emulate the functionality of the electronic apparatus. The functionality which the user 122 may use on the portable electronic device 14 may thus depend upon the nature and sophistication of the access device 12 within his or her proximity. For example, if the user 122 is proximate the PC 18 (see FIG. 1), and it is equipped with a sound card, the user 122 may use the portable electronic device 14 to emulate an MP3 player. The portable electronic device 14 will then simulate an MP3 player by communicating display data and emulation data to the PC 18. The display data defines a display layout on the display 36 that substantially simulates the physical appearance of the MP3 player and the emulation data defines MP3 files which are used by the sound card to provide an audio output to the user 122.

Thus, a method and device for emulating electronic apparatus has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A portable electronic device, which includes:
a wireless communication module to communicate with a separate access device in a wireless fashion;
a data storage module to store emulation data to emulate an electronic apparatus; and
a controller to control the communication of the emulation data to the access device to output to a user to emulate the electronic apparatus.

2. A device as claimed in claim 1, in which the data storage module stores display data, the portable electronic device being configured to communicate the display data to the access device to provide a display layout that simulates the physical appearance of the electronic apparatus.

3. A device as claimed in claim 2, in which the display layout is defined by a plurality of skins that are stored on the portable electronic device and communicated in a wireless fashion to the access device.

4. A device as claimed in claim 2, in which the display layout includes function buttons that substantially resemble function buttons on the electronic apparatus in appearance and which, when activated by a pointing device, cause the portable electronic device to execute substantially similar functions to the function buttons on the electronic apparatus.

5. A device as claimed in claim 1, in which the wireless communication module is a radio frequency (RF) device that communicates over a limited range using a standard wireless communication protocol.

6. A device as claimed in claim 5, in which the standard wireless communication protocol is selected from the group including Bluetooth IEEE 802.15, IEEE 802.11a, and IEEE 802.11b.

7. A device as claimed in claim 1, in which the access device includes a user multimedia interface, the portable electronic device being configured to communicate the emulation data to the user multimedia interface to provide an output to a user.

8. A device as claimed in claim 7, in which the access device exclusively defines an interface with the user and the multimedia interface provides an audio output device to output audio sourced from the portable electronic device.

9. A device as claimed in claim 8, in which the portable electronic device emulates the functionality of at least one electronic apparatus selected from the group including an MP3 player, a personal digital assistant (PDA), an electronic book, a dictionary, a calculator, a cellular telephone, a calorie counter, a game playing device, and a smart card.

10. A device as claimed in claim 7, in which the portable electronic device determines if the access device has the output capabilities to provide the functionality of the electronic apparatus prior to communicating the display data and the emulation data to the access device.

11. A device as claimed in claim 1, in which communication is effected using Universal Plug and Play standards.

12. An emulation system, which includes:
a portable electronic device to emulate functionality provided by an electronic apparatus, the portable electronic device including a wireless communication module and a data storage module to store emulation data; and
a separate access device including a wireless communication interface to communicate with the wireless communication module when the portable electronic device is within a wireless communication range of the access device, the portable electronic device communicating emulation data to the access device to output to a user to emulate the electronic apparatus.

13. A system as claimed in claim 12, in which the data storage module stores display data, the portable electronic device being configured to communicate the display data to the access device to provide a display layout that simulates the physical appearance of the electronic apparatus.

14. A system as claimed in claim 13, in which the display layout is defined by a plurality of skins that are stored on the portable electronic device.

15. A system as claimed in claim 13, in which the display layout includes function buttons that substantially resemble function buttons on the electronic apparatus in appearance and which, when activated by a pointing device, cause the system to execute substantially similar functions to the function buttons on the electronic apparatus.

16. A system as claimed in claim 12, in which the wireless communication module and interface are radio frequency (RF) devices that communicate over a limited range using a standard wireless communication protocol.

17. A system as claimed in claim 16, in which the standard wireless communication protocol is selected from the group including Bluetooth IEEE 802.15, IEEE 802.11a, and IEEE 802.11b.

18. A system as claimed in claim 12, in which the portable electronic device emulates the functionality of the electronic apparatus selected from the group including an MP3 player, a personal digital assistant (PDA), an electronic book, a dictionary, a calculator, a cellular telephone, a calorie counter, a game playing device, and a smart card.

19. A system as claimed in claim 12, in which the access device exclusively defines an interface with the user and the emulation data includes at least one of audio data, text data, and numeric data.

20. A method, which includes:
monitoring when a portable electronic device is within a wireless communication range of an access device, the portable electronic device emulating the functionality of an electronic apparatus; and
communicating emulation data stored on the portable electronic device to the access device in a wireless fashion to provide an output to a user.

21. A method as claimed in claim 20, which includes communicating display data to the access device to provide a display layout that simulates the physical appearance of the electronic apparatus.

22. A method as claimed in claim 21, in which the display data defines a plurality of skins that provide the display layout.

23. A method as claimed in claim 21, which includes:
communicating display data that defines a plurality of function buttons that substantially resemble function buttons on the electronic apparatus in appearance;
monitoring when a pointing device selects a particular function button;
executing the function on the portable electronic device; and
communicating emulation data to the access device to output to the user.

24. A method as claimed in claim 20, which includes communicating between the portable electronic device and the access device using a standard radio frequency (RF) wireless communication protocol.

25. A method as claimed in claim 20, in which the standard wireless communication protocol is selected from the group including Bluetooth IEEE 802.15, IEEE 802.11a, and IEEE 802.11b.

26. A method as claimed in claim 20, which includes emulating the functionality of at least one electronic apparatus selected from the group including an MP3 player, a personal digital assistant (PDA), an electronic book, a dictionary, a calculator, a cellular telephone, a calorie counter, a game playing device, and a smart card.

27. A method as claimed in claim 21, which includes determining if the access device has the capability to provide the display layout and output the emulation data prior to communicating the display data and emulation data to the access device.

28. A method as claimed in claim 20, which includes communicating using Universal Plug and Play standards.

29. A computer program product including a medium readable by a computer, the medium including instructions which, when executed by the computer, cause the computer to:
monitor when a portable electronic device is within a wireless communication range of an access device; and
communicate emulation data stored on the portable electronic device to the access device in a wireless fashion to output to a user to emulate the electronic apparatus.

30. A computer program product as claimed in claim 29, which includes communicating display data to the access device in a wireless fashion, the display data defining a display layout that substantially simulates a physical appearance of the electronic apparatus.

31. A computer program product as claimed in claim 29, in which the display data defines a plurality of skins that are displayed on the display.

32. A computer program product as claimed in claim 29, which:
communicates display data that defines a plurality of function buttons that substantially resemble function buttons on the electronic apparatus in appearance;
monitors when a pointing device selects a particular function button;
executes the function on the portable electronic device; and
communicates emulation data to the access device to output to the user.

33. A computer program product as claimed in claim 29, in which communication between the portable electronic device and the access device is by way of a standard radio frequency (RF) wireless communication protocol.

34. A computer program product as claimed in claim 33, in which the standard wireless communication protocol is selected from the group including Bluetooth IEEE 802.15, IEEE 802.11a, and IEEE 802.11b.

35. A computer program product as claimed in claim 29, which emulates the functionality of at least one electronic apparatus selected from the group including an MP3 player, a personal digital assistant (PDA), an electronic book, a dictionary, a calculator, a cellular telephone, a calorie counter, a game playing device, and a smart card.

36. A computer program product as claimed in claim 30, which determines if the access device has the capability to provide the display layout and output the emulation data prior to communicating the emulation data to the access device.

37. A computer program product as claimed in claim 29, which monitors when the portable electronic device and the access device are within a predetermined physical range, the physical range defining a restricted zone within which the access device assumes that a user bearing the portable electronic device requires use of the access device.

38. A computer program product as claimed in claim 29, which communicates using Universal Plug and Play standards.
